(19) United States
(12) Patent Application Publication
(10) Pub. No.: US 2014/0353089 A1
(43) Pub. Date: Dec. 4, 2014

(54) VEHICLE ELEVATOR SYSTEM

(71) Applicant: Unitronics Parking Solutions Ltd., Ben Gurion Airport (IL)

(72) Inventors: Haim SHANI, Shoham (IL); Zvi RAZ, Petach Tikva (IL)

(21) Appl. No.: 13/902,996

(22) Filed: May 28, 2013

(51) Int. Cl. B66B 9/00

(52) U.S. Cl. CPC B66B 9/00
USPC 187/254

(57) ABSTRACT

A vehicle elevator system including a transport platform for transporting a vehicle to and from a parking floor in a multi-story parking facility; a hoisting element attached at one end to the transport platform and at another end to a counterweight; a motor-driven hoist transport element to impart motion to the hoisting element; a tensed cable attached at one end to the transport platform and at another end to the counterweight; and a pulley to allow sliding motion of the tensed cable.

### FIELD OF THE INVENTION

The present invention relates to vehicle elevator systems for use in vehicle parking facilities generally and to a vehicle elevator support system in particular.

### BACKGROUND OF THE INVENTION

Vehicle elevator systems are frequently used in multi-story parking facilities to transport a vehicle between floors. Their use may be potentially advantageous, particularly in facilities which are relatively limited in space, as drive ramps typically used to connect between floors may be eliminated.

Vehicle elevator systems may be configured for use with driver-occupied vehicles and with driver-less vehicles. When configured for a driver-occupied vehicle, a driver, which may be a parking attendant, sits inside a vehicle in a vehicle elevator as the vehicle is lifted to, and retrieved from, a respective floor where it is parked. When configured for a driver-less vehicle, the vehicle elevator is generally part of an automated parking facility which generally includes parking slots in each floor into which a vehicle is placed and retrieved by an automated conveying system. In automated parking facilities, drivers typically self-drive their vehicle into a vehicle entry station where it may be accessed by a transport mechanism which is part of the automated conveyor system. The transport mechanism may then transport the vehicle into the vehicle elevator which transports the vehicle to the respective floor where it is to be parked. A vehicle transport mechanism, which may be the same which transported the vehicle into the elevator, removes the vehicle from the elevator and transports the vehicle to its respective parking space. Retrieving the vehicle generally involves the same procedure, but reversed. Examples of three configurations of known vehicle elevator systems are shown in FIGS. 1, 2 and 3.

In FIG. 1, known vehicle elevator system 10 includes a transport platform 12 in which a driver-less vehicle 11, or alternatively a driver-occupied vehicle, is positioned inside for transport to and from a parking floor. Elevator system 10 may include a hoisting element 15 such as, for example, hoist cables, hoist chains, or hoist belts, attached at one end to transport platform 12 and at another end to a counterweight 16. Counterweight 16 may be of a weight equal to the weight of transport platform 12 and approximately 40%-60% of the weight of a vehicle transported by vehicle elevator system. The weight of the vehicle may be estimated to be the average weight of all vehicles which may be transported in transport platform 12, or alternatively, the weight of the heaviest vehicle which may be transported in the transport platform. The weight of counterweight 16 may be representative of the average weight of transport platform 12 when loaded with vehicle 11 and when empty of the vehicle.

Hoisting element 15 may be supported by a hoist transport element 13 driven by a motor 14 which rotates the hoist transport element in a clockwise or counterclockwise direction depending on a direction of travel of transport platform 12. Hoist transport element 13 may include a sprocket, a sheave or other type of mechanical element suitable to support hoisting element 15 and to impart motion to the hoisting element. For example, to lower transport platform 12, motor 14 may rotate hoist transport element 13 in a counterclockwise direction and in a clockwise direction to raise the transport platform. Motor 14 may be attached to a gear train (not shown) which rotates hoist transport element 13. Motor 14 rotational force applied to hoist transport element 13 may overcome frictional forces exerted on transport platform 12 and counterweight 16 while travelling along guide rails (not shown) which support the transport platform and the counterweight. Motor 14 rotational force may additionally serve to overcome additional loading in transport platform 12 when occupied by vehicle 11 (as counterweight 16 accounts for the weight of transport platform 12 and 40%-60% of average weight), and to control a speed of ascent and descent of the transport platform.

FIG. 2 shows known vehicle elevator system 20 with two hoist transport elements 23A and 23B and two motors 24A and 24B, respectively. In vehicle elevator system 20, transport platform 12 is connected through two hoisting elements 25A and 25B to two counterweights 26A and 26B respectively. The weight of transport platform 12 and vehicle 11 is distributed between counterweights 26A and 26B, instead of a single counterweight 16 as shown in FIG. 1 (each counterweight may be half the weight of counterweight 16).

The configuration shown in FIG. 2 may be particularly advantageous with respect to that of vehicle elevator system 10 in FIG. 1 as hoist transport elements 23A and 23B, and/or motors 24A and 24B may be smaller compared to hoist transport element 13 and/or motor 14. Additionally, each hoisting element 25A and 25B may have a less load carrying capacity than hoisting element 15. Possible drawbacks with vehicle elevator system 20 compared with vehicle elevator system 10 may include additional costs associated with installing and maintaining two support systems (i.e. a first support system includes hoisting element 25A, hoist transport element 23A, motor 24A and counterweight 26A; second support system includes hoisting element 25B, hoist transport element 23B, motor 24B and counterweight 26B). Also required may be equipment to control synchronized operation of motors 23A and 23B so that the motors operate simultaneously and the operation of both hoist transport elements is substantially simultaneous. Additionally, each counterweight 26A and 26B may require its own set of guide rails along which they travel and are supported.

FIG. 3 shows known vehicle elevator system 30 having two hoist transport elements 33A and 33B and two motors 34A and 34B, respectively. In vehicle elevator system 30, transport platform 12 is connected through two hoisting elements 35A and 35B to one counterweight 36. This configuration may be particularly advantageous over vehicle elevator system 20 as the weight of platform 12 and vehicle 11 is distributed between two hoisting elements 35A and 35B and two transport mechanism 33A and 34B similar to vehicle elevator system 20, but only one counterweight 36 is used (only one set of guide rails is required to support the counterweight instead of two as required by vehicle elevator system 20).

The known vehicle elevator configurations previously described and shown in FIGS. 1-3 are for exemplary purposes only, and may include use of more hoisting elements and hoist transport elements. For example, referring to FIG. 2, transport platform 12 may be supported by four hoisting elements, four hoist transport elements with motors, and four counterweights. Referring to FIG. 3, transport platform 12 maybe supported by four hoisting elements, four hoist transport elements with motors, and a single counterweight, or alternatively, two counterweights (two hoisting elements attached to each counterweight).

### SUMMARY OF THE PRESENT INVENTION

There is provided, according to an embodiment of the present invention, a vehicle elevator system including a transport platform for transporting a vehicle to and from a parking floor in a multi-story parking facility; a hoisting element attached at one end to the transport platform and at another end to a counterweight; a motor-driven hoist transport element to impart motion to the hoisting element; a tensed cable attached at one end to the transport platform and at another end to the counterweight; and a pulley to allow sliding motion of the tensed cable.

According to an exemplary embodiment, the pulley includes an idle pulley.

According to an exemplary embodiment, the hoisting element includes a hoisting cable.

According to an exemplary embodiment, the hoisting element includes a hoisting chain.

According to an exemplary embodiment, the hoisting element includes a hoist belt.

According to an exemplary embodiment, the motor-driven hoist transport element is a sheave.

According to an exemplary embodiment, the motor-driven hoist transport element is a sprocket.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an exemplary configuration of a known vehicle elevator system having one support system;

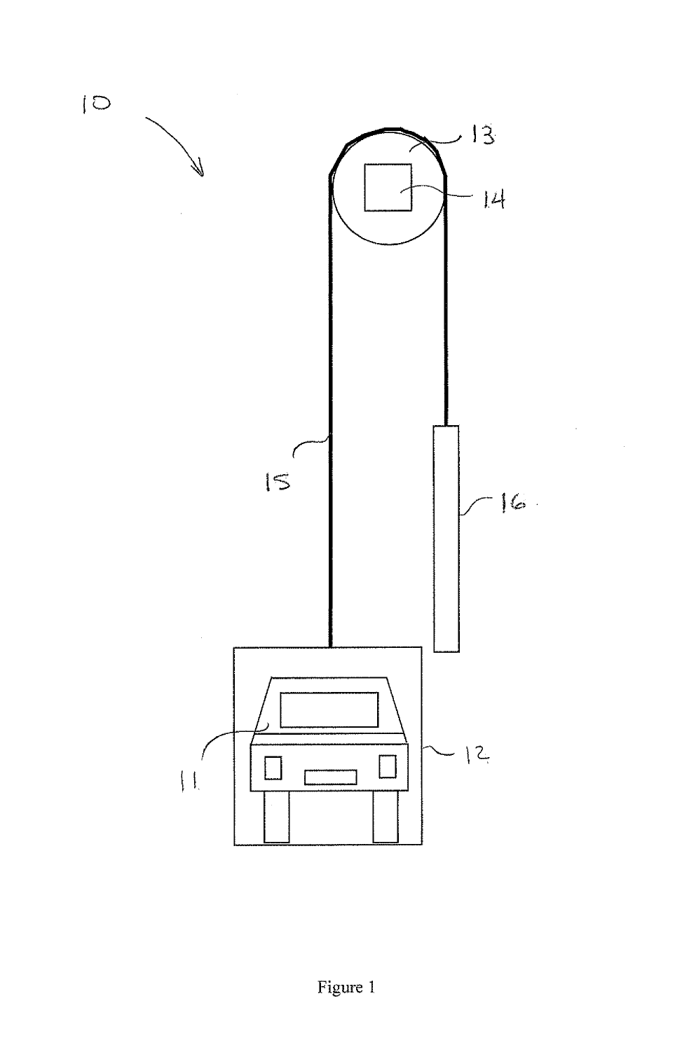

FIG. 2 schematically illustrates another exemplary configuration of a known vehicle elevator system having multiple support systems with multiple counterweights;

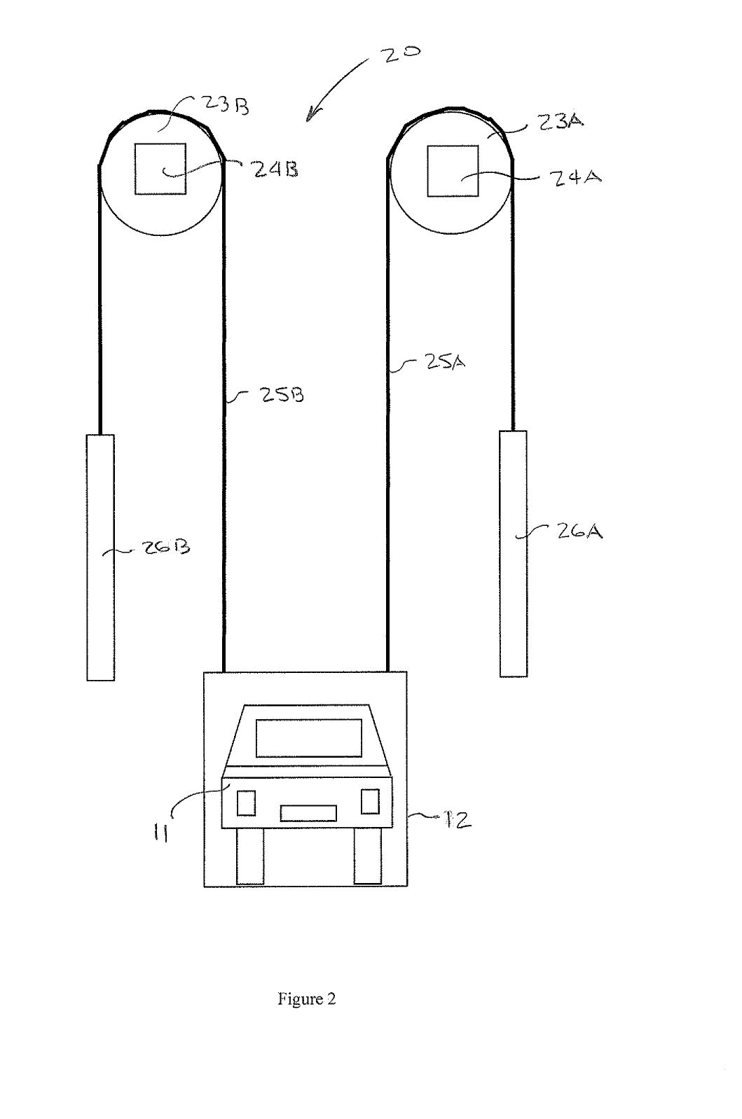

FIG. 3 schematically illustrates another exemplary configuration of a known vehicle elevator system having multiple support systems with one counterweight;

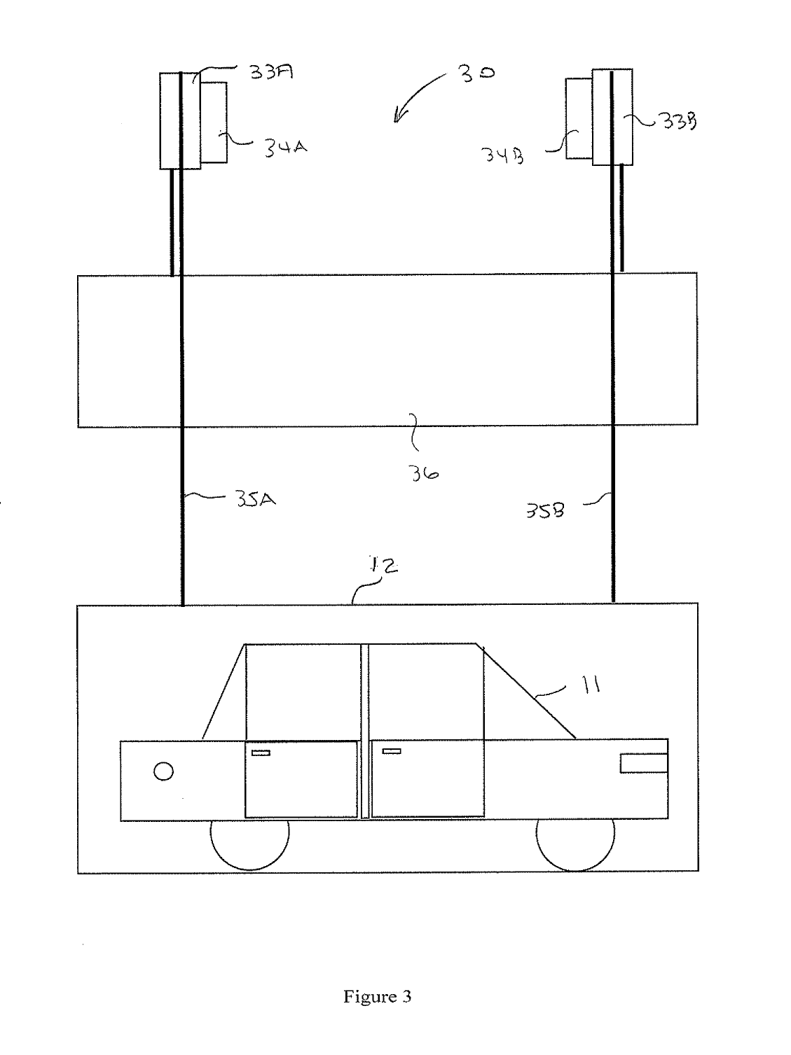

FIG. 4 schematically illustrates an exemplary configuration of an improved vehicle elevator system with one counterweight, according to an embodiment of the present invention;

FIG. 5 schematically illustrates another exemplary configuration of an improved vehicle elevator system with multiple counterweights, according to an embodiment of the present invention; and

FIG. 6 schematically illustrates another exemplary configuration of an improved vehicle elevator system with one counterweight, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that known vehicle elevator systems may be improved by additionally supporting the transport platform using one or more tensed cables riding on pulleys, the cables attached at one end to the transport platform and at the other end to the counterweight. The tensed cable and pulley combination may reduce loading on hoisting elements (e.g. hoist chains, hoist cables, hoist belts) and may allow reducing the size of the hoisting elements. Additionally or alternatively, the tensed cable and pulley combination may allow increasing the ascent and descent speed of the transport platform, for example, from 1 msec to 2 m/sec or more. Additionally, the tensed cable and pulley combination may serve as redundant support elements in case of failure (breaking) in the hoisting element.

Applicants have further realized that the tensed cable and pulley combination may be used with any elevator system which includes a support system having a hoisting element, a motor-driven hoist transport elements, and a counterweight; and its use is not limited to vehicle elevator systems. For example, the tensed cable and pulley combination may be used with passenger elevators, freight elevators, and other types of elevator systems known in the art.

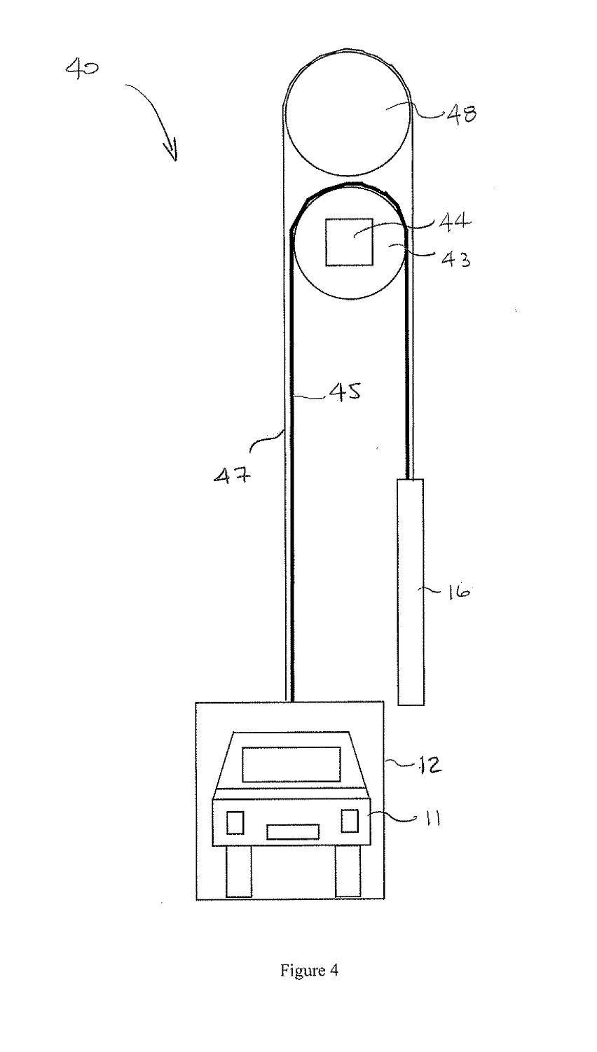

Reference is now made to FIG. 4 which schematically illustrates an exemplary improved vehicle elevator system 40 with single counterweight 16, according to an embodiment of the present invention. Vehicle elevator system 40 includes transport platform 12 and may have one or more hoisting elements 45 attached at one end to transport platform 12 and at another end to counterweight 16. Hoisting elements 45 may be supported by a hoist transport element 43 which is driven by a motor 44 which rotates the hoist transport element in a clockwise or counterclockwise direction depending on a direction of travel of transport platform 12. For example, to lower transport platform 12, motor 44 may rotate hoist transport element 43 in a counterclockwise direction and in a clockwise direction to raise the transport platform. Motor 44 may be attached to a gear train (not shown) which rotates hoist transport element 43.

Vehicle elevator system 40 additionally includes a tensed cable 47 attached at one end to transport platform 12 and at its other end to counterweight 16. Tensed cable 47 rides on a pulley 48, which may be for example an idle pulley, which supports the tensed cable and thereby transport platform 12 and counterweight 16. Tensed cable 47, which may operate in parallel to hoisting element 45, may apply a tension to transport platform 12 and to counterweight 16 substantially reducing the load imposed on the hoisting element by the transport platform and the counterweight. This load reduction may allow reducing the size of hoisting element 45. Additionally or alternatively, this load reduction may allow for increasing an ascent and a descent time of transport platform. Additionally, tensed cable 47 may serve to support transport platform 12 and counterweight 16 in case hoisting element 45 snaps.

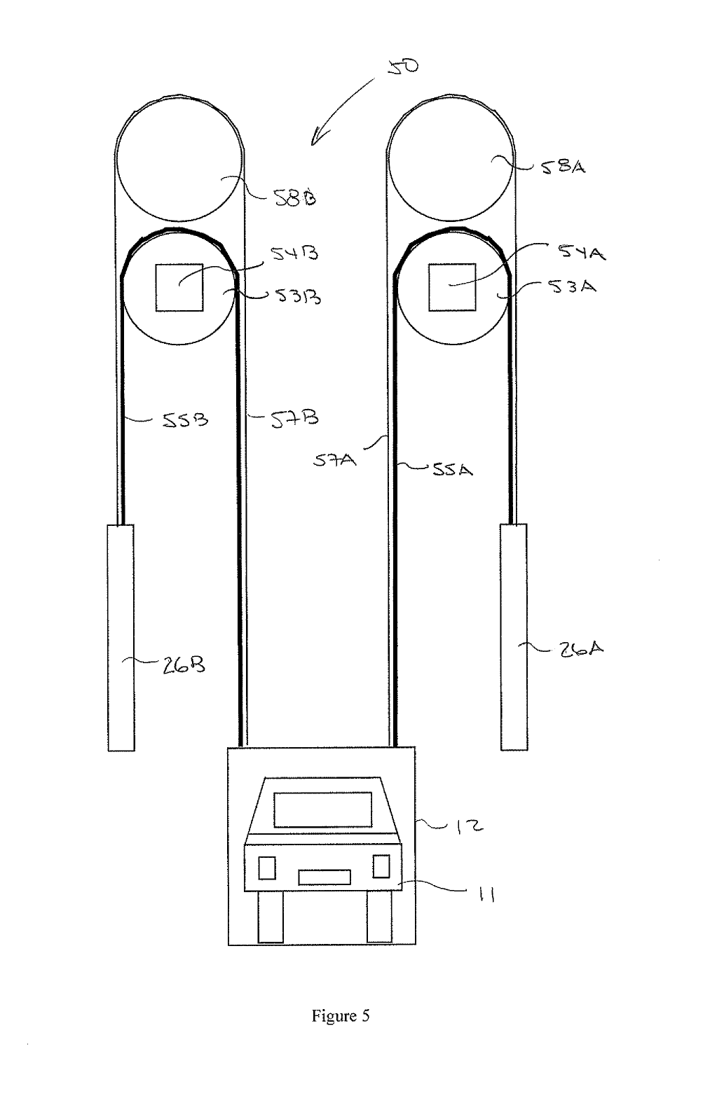

Reference is now made to FIG. 5 which schematically illustrates an exemplary improved vehicle elevator system 50 with multiple counterweights 26A and 26B, according to an embodiment of the present invention. In vehicle elevator system 50, two hoisting elements 55A and 55B are supported by two hoist transport elements 53A and 53B and attached to transport platform 12 at one end, and to counterweights 26A and 26B at the other end, respectively. The weight of transport platform 12 and vehicle 11 is distributed between counterweights 26A and 26B, instead of a single counterweight 16 as shown in FIG. 4 (each counterweight may be half the weight of counterweight 16, for example). Hoist transport elements 53A and 53B may each be driven by a motor 54A and 54B, respectively which rotate the hoist transport elements in a clockwise or counterclockwise direction depending on a direction of travel of transport platform 12. A synchronization device (not shown) may be used to simultaneously activate both motors to synchronize their rotation. Motors 54A and 54B may each be attached to a gear train (not shown) which rotates hoist transport elements 53A and 53B.

Vehicle elevator system 50 additionally includes tensed cables 57A and 57B, each attached at one end to transport platform 12 and at its other end to counterweights 26A and 26B, respectively. Tensed cables 57A and 57B ride on pulleys 58A and 58B, respectively, which may be for example idle pulleys, which support the tensed cables and thereby transport platform 12 and counterweights 26A and 26B. Tensed cables 57A and 57B, which may operate in parallel to hoisting elements 55A and 55B, respectively, may apply a tension to transport platform 12 and to counterweights 26A and 26B, substantially reducing the load imposed on the respective hoisting elements by the transport platform and the counterweights. This load reduction may allow reducing the size of hoisting elements 55A and 55B. Additionally or alternatively, this load reduction may allow for increasing an ascent and a descent time of transport platform 12. Additionally, tensed cables 57A and 57B may serve to support transport platform 12 and counterweights 26A and 26B in case hoisting element 55A and/or 55B snaps.

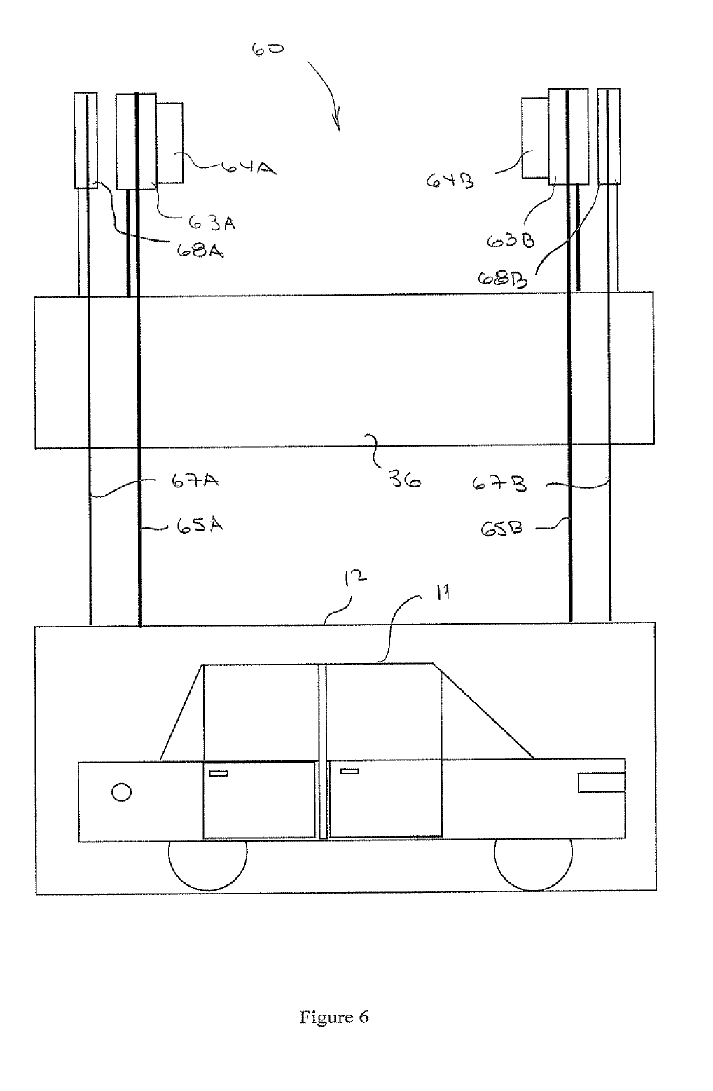

Reference is now made to FIG. 6 which schematically illustrates an exemplary improved vehicle elevator system 60 with single counterweight 36. In vehicle elevator system 60, two hoisting elements 65A and 65B are supported by two hoist transport elements 63A and 63B and attached to transport platform 12 at one end, and to single counterweight 36 at the other end, respectively. This configuration may be particularly advantageous over vehicle elevator system 50 as the weight of platform 12 and vehicle 11 is distributed between two hoisting elements 65A and 65B and two hoist transport elements 63A and 63B similar to vehicle elevator system 50, but only one counterweight 36 is used. Hoist transport elements 63A and 63B may each be driven by a motor 64A and 64B, respectively which rotate the hoist transport elements in a clockwise or counterclockwise direction depending on a direction of travel of transport platform 12. A synchronization device (not shown) may be used to simultaneously activate both motors to synchronize their rotation. Motors 64A and 64B may each be attached to a gear train (not shown) which rotates hoist transport elements 63A and 63B.

Vehicle elevator system 60 additionally includes tensed cables 67A and 67B, each respectively attached at one end to transport platform 12 and at the other end to counterweight 36. Tensed cables 67A and 67B ride on pulleys 68A and 68B, respectively, which may be for example idle pulleys, which support the tensed cables and thereby transport platform 12 and counterweight 36. Tensed cables 67A and 67B, which may operate in parallel to hoisting elements 65A and 65B, respectively, may apply a tension to transport platform 12 and to counterweight 36, substantially reducing the load imposed on the respective hoisting elements by the transport platform and the counterweight. This load reduction may allow reducing the size of hoisting elements 65A and 65B. Additionally or alternatively, this load reduction may allow for increasing an ascent and a descent time of transport platform 12. Additionally, tensed cables 67A and 67B may serve to support transport platform 12 and counterweight 36 in case hoisting element 65A and/or 65B snaps.

Vehicle elevator systems 40, 50, and 60 shown in FIGS. 4-6 are for exemplary purposes only, and may include use of more hoisting elements and hoist transport elements, and more tensed cable and pulley combinations. In vehicle elevator systems 40, 50, and 60, a tensed cable and pulley combination may be provided for each hoisting element attached to platform 12 and to the counterweights. Each tensed cable and pulley combination may then work in parallel redundancy with each hoisting element and hoist transport element. For example, referring to FIG. 4, transport platform 12 may be supported by four hoisting elements, four hoist transport elements with motors, and four counterweights. Additionally, four tensed cable and pulley combinations may be used, with each tensed cable attached to the platform at one end and to one of the counterweights at the other end (one tensed cable to each counterweight). Referring to FIG. 6, transport platform 12 maybe supported by four hoisting elements, four hoist transport elements with motors, and a single counterweight, or alternatively, two counterweights (2 hoisting cables attached to each counterweight). Additionally, transport platform 12 may be supported by four tensed cable and pulley combinations with all tensed cables connected at one end to the platform and at the other end to the counterweight.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A vehicle elevator system comprising:
a transport platform for transporting a vehicle to and from a parking floor in a multi-story parking facility;
a hoisting element attached at one end to said transport platform and at another end to a counterweight;
a motor-driven hoist transport element to impart motion to said hoisting element;
a tensed cable attached at one end to said transport platform and at another end to said counterweight; and
a pulley to allow sliding motion of said tensed cable.

2. A system according to claim 1 wherein said pulley comprises an idle pulley.

3. A system according to claim 1 wherein said hoisting element comprises a hoisting cable.

4. A system according to claim 1 wherein said hoisting element comprises a hoisting chain.

5. A system according to claim 1 wherein said hoisting element comprises a hoist belt.

6. A system according to claim 1 wherein said motor-driven hoist transport element is a sheave.

7. A system according to claim 1 wherein said motor-driven hoist transport element is a sprocket.
